(19) United States
(12) Patent Application Publication
(10) Pub. No.: US 2014/0205974 A1
(43) Pub. Date: Jul. 24, 2014

(54) STATISTICAL MACHINE TRANSLATION FRAMEWORK FOR MODELING PHONOLOGICAL ERRORS IN COMPUTER ASSISTED PRONUNCIATION TRAINING SYSTEM

(71) Applicant: Rosetta Stone, Ltd., Harrisonburg, VA (US)

(72) Inventors: Bryan Pellom, Erie, CO (US); Theban Stanley, Boulder, CO (US); Kadri Hacioglu, Boulder, CO (US)

(73) Assignee: Rosetta Stone, Ltd., Harrisonburg, VA (US)

(21) Appl. No.: 14/141,774

(22) Filed: Dec. 27, 2013

Related U.S. Application Data
(63) Continuation of application No. PCT/US2012/044992, filed on Jun. 29, 2012.
(60) Provisional application No. 61/503,325, filed on Jun. 30, 2011.

(51) Int. Cl. G09B 19/06; G06F 17/28

(52) U.S. Cl. CPC G09B 19/06; G06F 17/28
USPC 434/157

(57) ABSTRACT

Methods and systems for teaching a user a non-native language include creating models representing phonological errors in the non-native language and generating with the models non-native pronunciations for a native pronunciation. The non-native pronunciations may be used for detecting phonological errors in an utterance spoken in the non-native language by the user. The models can include a native to non-native phone translation model and a non-native phone language model.

### FIELD

The disclosure relates to language instruction. More particularly, the present disclosure relates to a system and method for modeling of phonological errors and related methods.

### BACKGROUND

The use of technology in classrooms has been steadily increasing in the past decade and the comfort level of students in using technology has never been higher. Computer Assisted Pronunciation Training (CAPT) has been quietly inching its way into many language learning curriculum. The high demand and shortage of language tutors especially in Asia has lead to CAPT systems playing a prominent and increasing role in language learning.

CAPT systems can be very effective among language learners who prefer to go through the curriculum at their own pace. Also, CAPT systems exhibit infinite patience while administering repeated practice drills which is a necessary evil in order to achieve automaticity. Most CAPT systems are first language (L1) independent (i.e., the language learners first language) and cater to a wide audience of language learners from different language backgrounds. These systems take the learner through pre-designed prompts and provide limited feedback based on the closeness of the acoustics of the learners' pronunciation to that of native/canonical pronunciation. In most of these systems, the corrective feedback, if any, is implicit in the form of pronunciation scores. The learner is forced to self-correct based on his/her own intuition about what went wrong. This method can be very ineffective especially when the learner suffers from the inability to perceive certain native sounds.

A recent trend in CAPT systems is to capture language transfer effects between the learner's L1 and L2 (second language) languages. This makes the CAPT system better equipped to detect, identify and provide actionable feedback to the learner. These specialized systems have become more viable with enormous demand for English language learning products in Asian countries like China and India. If the system is able to successfully pinpoint errors, it can not only help the learner identify and self-correct a problem, but can also be used as input for a host of other applications including content recommendation systems and individualized curriculum-based systems. For example, if the learner consistently mispronounces a phoneme (the smallest sound unit in a language capable of conveying a distinct meaning), the learner can be recommended remedial perception exercises before continuing the speech production activities. Also, language tutors can receive regular error reports on learners, which might be very useful in periodic tuning of customizable curriculum.

Linguistic experience and literature can be used to get a collection of error rules that represent negative transfer effects for a given L1-L2 pair. But this is not a foolproof process as most linguists are biased to certain errors based on their personal experience. Also, there are always inconsistencies among literature sources that list error rules for a given L1-L2 pair. Most of the relevant studies have been conducted on limited speaker population and most of them lack sufficient coverage of all phonological error phenomena. It might be very convenient and cost effective to automatically derive error rules from L2 data.

The prior art has tried automatically deriving context sensitive phonological (i.e., speech sounds in a language) rules by aligning the canonical pronunciations with phonetic transcriptions (i.e., visual representation of speech sounds) obtained from an annotator. Most alignment techniques used in similar automated approaches are variants of a basic edit distance (ED) algorithm. The algorithm is constrained to one-to-one mapping which is ineffective in discovering phonological error phenomena that occur over phone chunks. As edit distance based techniques poorly model dependencies between error rules, it's not straightforward to generate all possible non-native pronunciations given a set of error rules. Extensive rule selection and application criteria need to be developed as such criteria is not modeled as part of the alignment process.

Accordingly, a system and method is needed for modeling phonological errors.

### SUMMARY

Disclosed herein is method for teaching a user a non-native language. The method comprises creating, in a computer process, models representing phonological errors in the non-native language; and generating with the models, in a computer process, non-native pronunciations for a native pronunciation.

Further disclosed herein is a system for teaching a user a non-native language. In some embodiments, the system comprises a word aligning module for aligning native pronunciations with corresponding non-native pronunciations, the aligned native and non-native pronunciations for use in creating a native to non-native phone translation model; a language modeling module for generating a non-native phone language model using annotated native and non-native phone sequences; and a non-native pronunciation generator for generating non-native pronunciations using the phone translation and phone language models.

In other embodiments, the system comprises a memory containing instructions and a processor executing the instructions contained in the memory. The instructions, in some embodiments, may include aligning native pronunciations with corresponding non-native pronunciations, the aligned native and non-native pronunciations for use in creating a native to non-native phone translation model; generating a non-native phone language model using annotated native and non-native phone sequences; and generating non-native pronunciations using the phone translation and phone language models.

The instructions in other embodiments may include creating models representing phonological errors in the non-native language; and generating with the models non-native pronunciations for a native pronunciation.

### BRIEF DESCRIPTION OF THE DRAWINGS

FIG. 1 is a block diagram of an exemplary embodiment of a machine translation (MT) sub-system.

FIG. 2 is a block diagram of an exemplary embodiment of a phonological error modeling (PEM) system.

FIG. 3 is a block diagram showing the PEM system of FIG. 2 used with an exemplary embodiment of a CAPT system.

FIG. 4 is a flow chart of a non-native target language pronunciation method, according to an exemplary embodiment of the present disclosure.

FIG. 5A is a table showing the performances of the PEM system of the present disclosure and a prior art ED (edit distance) system normalized to Human performance (set at 100%) in phone error detection.

FIG. 5B are graphs comparing the normalized performance of F-1 score in phone error detection for varying numbers of pronunciation alternatives of the PEM and prior art ED systems.

FIG. 6A is a table showing the performances of the PEM system of the present disclosure and the prior art ED systems normalized to Human performance (set at 100%) in phone error identification.

FIG. 6B are graphs comparing the normalized performance of F-1 score in phone error identification for varying numbers of pronunciation alternatives of PEM and prior art ED systems.

FIG. 7 is a block diagram of an exemplary embodiment of a language instruction or learning system according to the present disclosure.

FIG. 8 is a block diagram showing of an exemplary embodiment a computer system of the language learning system of FIG. 7.

### DETAILED DESCRIPTION

The present disclosure presents a system for modeling phonological errors in non-native language data using statistical machine translation techniques. In some embodiments, the phonological error modeling (PEM) system may be a separate and discrete system while in other embodiments, the PEM system may be a component of sub-system of a CAPT system. The output of the PEM system may be used by a speech recognition engine of the CAPT system to detect non-native phonological errors.

The PEM system of the present disclosure formulates the phonological error modeling problem as a machine translation (MT) problem. A MT system translates sentences in a source language to a sentence in a target language. The PEM system of the present disclosure may comprise a statistical MT sub-system that considers canonical pronunciation to be in the source language and then generates the best non-native pronunciation (target language to be learned) that is a good representative translation of the canonical pronunciation for a given L1 population (native language speakers). The MT sub-system allows the PEM system of the present disclosure to model phonological errors and modeling dependencies between error rules. The MT sub-system also provides a more principled search paradigm that is capable of generating N-best non-native pronunciations for a given canonical pronunciation.

MT relates to the problem of generating the best sequence of words in the target language (language to be learned) that is a good representation of a sequence of words in the source language. The Bayesian formulation of the MT problem is as follows:

$$P ( T \vert S ) = {arg max}_{T} P ( S \vert T ) \cdot P ( T ) \qquad ( 1 )$$

where, T and S are word sequences in the target and source languages respectively. P(S|T) is a translation model that models word/phrase correspondences between the source (native) and target (non-native) languages. P(T) represents a language model of the target language. The MT sub-system of the PEM system of the present disclosure may comprise a Moses phrase-based machine translation system.

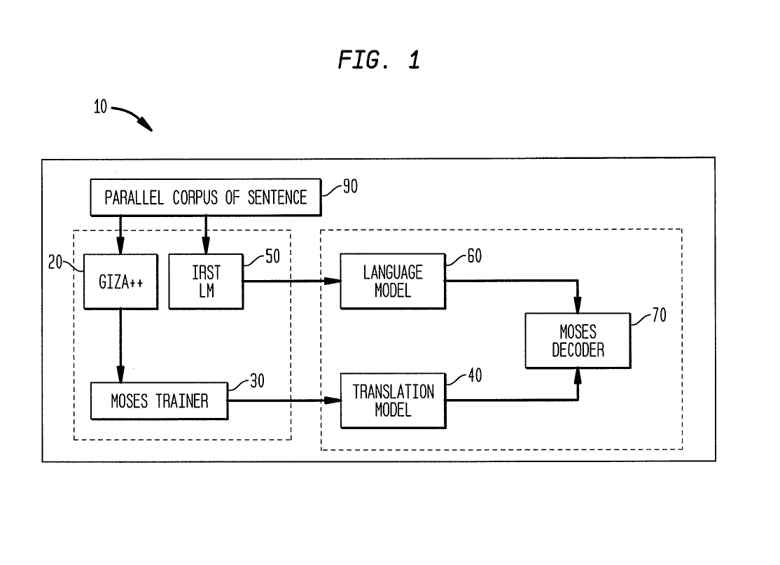

FIG. 1 is a block diagram of an exemplary embodiment of the MT sub-system 10 according to the present disclosure. Estimation of a native to non-native error translation model 40 may require a parallel corpus of sentences 90 in the source and target languages. Word alignments between the source and target language may be obtained in some embodiments of the MT sub-system 10 using a word aligning toolkit 20, which in some embodiments may comprise a Giza++ toolkit. The Giza++ toolkit 20 is an implementation of the original IBM machine translation models. The Giza++ toolkit 20 has some drawbacks including limitation to one-to-one mapping, which is not necessarily true for most language pairs. In order to obtain more realistic alignments, a trainer 30 may be used to apply a series of transformations to the word alignments produced by the Giza++ toolkit 20 to grow word alignments into phrasal alignments. The trainer 30, in some embodiments, may comprise a Moses trainer. The parallel corpus of sentences 90 may be aligned in both directions i.e., source language against the target language and vice versa. The two word alignments may be reconciled by obtaining an intersection that gives high precision alignment points (the points carrying high confidence). By taking the union of these two alignments, one can obtain high recall alignment points. In order to grow the alignments, the space between the high precision alignment points and the high recall alignment points is explored. The trainer 30 may start with the intersection of the two word alignments and then adds new alignment points that exist in the union of the two word alignments. The trainer 30 may use various criteria and expansion heuristics for growing the phrases. This process generates phrase pairs of different word lengths with corresponding phrase translation probabilities based on their relative frequency of occurrence in the parallel corpus of sentences 90.

Language model 60 learns the most probable sequence of words that occur in the target language. It guides the search during a decoding phase by providing prior knowledge about the target language. The language model 60, in some embodiments, may comprise a trigram (3-gram) language model 60 with Witten-Bell smoothing applied to its probabilities. A decoder 70 can read language models 60 created from popular open source language modeling toolkits 50 including but not limited to SRI-LM, RandLM and IRST-LM.

The decoder 70 may comprise a Moses decoder. The Moses decoder 70 implements a beam search to generate the best sequence of words in the target language that represents the word sequence in the source language. At each state, the current cost of the hypothesis is computed by combining the cost of previous state with the cost of the translating the current phrase and the language model cost of the phrase. The cost also includes a distortion metric that takes into account the difference in phrasal positions between the source and the target language. Competing hypotheses can potentially be of different lengths and a word can compete with a phrase as a potential translation. In order to solve this problem, a future cost is estimated for each competing path. As the search space is very large for an exhaustive search, competing paths are pruned away using a beam which is usually based on a combination of a cost threshold and histogram pruning.

In accordance with the present disclosure, phonological errors in L2 (non-native target language) data are reformulated as a machine translation problem by considering a native/canonical phone sequence to be in the source language and attempting to generate the best non-native phone sequence (non-native target language) that represents a good translation of the native/canonical phone sequence. The corresponding Bayesian formulation may comprise:

$$P ( NN \vert N ) = {arg max}_{NN} P ( N \vert NN ) \cdot P ( NN ) \qquad ( 2 )$$

where, N and NN are the corresponding native and non-native phone sequences. P(N|NN) is a translation model which models the phonological transformations between the native and non-native phone sequences. P(NN) is a language model for the non-native phone sequences, which models the likelihood of a certain non-native phone sequence occurring in L2 data.

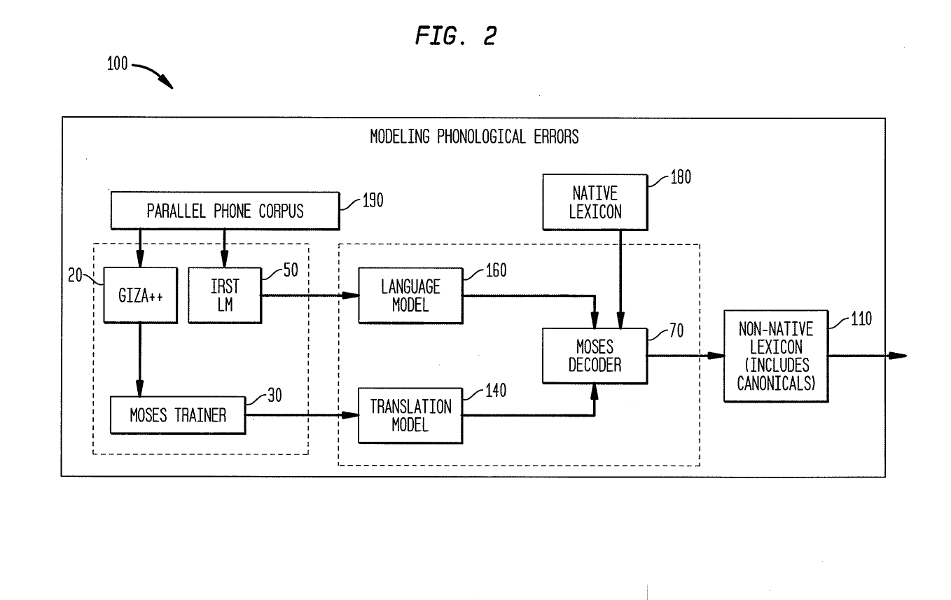

FIG. 2 is a block diagram of an exemplary embodiment of the PEM system 100 of the present disclosure. The PEM system 100 may comprise the word aligning toolkit 20, trainer (native to non-native phone translation trainer) 30, language modeling toolkit 50, and decoder 70 of the MT sub-system. The PEM system 100 may also comprise a native to non-native phonological error translation model 140, a non-native phonological language model 160, a native lexicon unit 180, and a non-native lexicon unit 110.

The training of the phonological translation error and non-native phone language models 140 and 160, respectively, will now be described. A parallel phone (pronunciation) corpus of canonical (native pronunciations) and annotated phone sequences (non-native pronunciations) from L2 data 190, are applied to the word aligning and language modeling toolkits 20 and 50, respectively. The parallel phone corpus may include prompted speech data from an assortment of different types of content. The parallel phone corpus may include minimal pairs (e.g. right/light), stress minimal pairs (e.g. CONtent/conTENT), short paragraphs of text, sentence prompts, isolated loan words and words with particularly difficult consonant clusters (e.g. refrigerator). Phone level annotation may be conducted on each corpus by plural human annotators (e.g. 3 annotators). The word aligning toolkit 20 generates phone alignments in response to the applied phone corpus 190. The phone alignments at the output of the word aligning toolkit 20, are applied to the native to non-native phone translation trainer 30, which grows the one-to-one phone alignments into phone-chunk based alignments, thereby training the phonological translation model 140. This process is analogous to growing word alignments into phrasal alignments in traditional machine translation. For example, but not limitation, if p1, p2 and p3 are native phones and np1, np2, np3 are non-native phones (they occur one after the other in a sample phone sequence), the one-to-one phone alignments may comprise p1-to np1, p2-to-np2 and p3-to-np3 (three separate phone alignments). The trainer 30 may then grow these one-to-one phone alignments into phone-chunk p1p2p3-to-np1np2np3.

The resulting phonological translation error model 140 may have phone-chunk pairs with differing phone lengths and a translation probability associated with each one of them. The application of the annotated phone sequences from the L2 data of the parallel phone corpus 190 to the language modeling toolkit 50 trains the non-native phone language model 160.

Given the phonological (phone) translation error model 140 and the non-native phonological (phone) language model 160, the decoder (non-native pronunciation generator) 70 can generate N-best non-native phone sequences for a given canonical native phone sequence supplied by the native lexicon unit 180 (contains native pronunciations) which are stored in the non-native pronunciation lexicon unit 110.

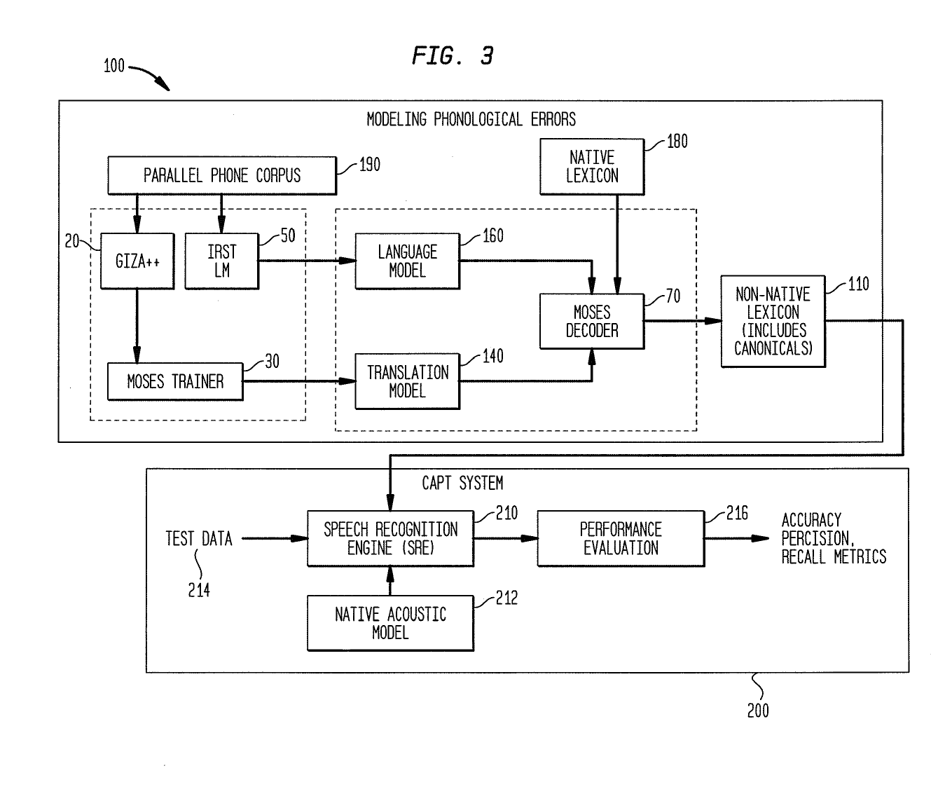

FIG. 3 is a block diagram showing the PEM system 100 of FIG. 2 used with an exemplary embodiment of a CAPT system 200. As shown, the non-native pronunciation lexicon unit 110 of the PEM system 100 is data coupled with a speech recognition engine (SRE) 210 of the CAPT system 200. The non-native pronunciation generator 70 uses the phonological error model 140 and non-native phone language model 160, to automatically generate non-native alternatives for every native pronunciation supplied by the native pronunciation lexicon 80. The non-native pronunciation generator 70 is capable of generating N-best lists and in some embodiments, based on empirical observations, a 4-best list may be used to strike a good balance between under generation and over generation of non-native pronunciation alternatives. In order to recognize an utterance 214 spoken by a language learner in the target language (i.e., find the most likely phone sequence that was spoken by the learner), the SRE 210 of the CAPT system 200 receives as input the non-native lexicon (includes canonical pronunciations) stored in the non-native lexicon unit 110 of the PEM system 100 and a native language acoustic model 212. The native acoustic model 212 models the different sounds in a spoken language and provides the SRE 210 with the ability to discern differences in the sound patterns in the spoken data. Acoustic models may be trained from audio data which is a good representation of the sounds in the language of interest The native acoustic model 212 is trained on native speech data from native speakers of L2. In other embodiments, a non-native acoustic model trained from non-native data may be used with the SRE 210. In some embodiments of the SRE 210, the expected utterance to be produced may be known, and utterance verification may be performed followed by aligning the audio and the expected text (expected sentence/prompt) using, for example, a Viterbi processing method. The search space may be constrained to the native and non-native variants of the expected utterance. The phone sequence that maximizes the Viterbi path probability (in the case of Viterbi processing) is then aligned against the native/canonical phone sequence to extract the phonological errors produced by the learner. The errors may then be evaluated by performance block 216.

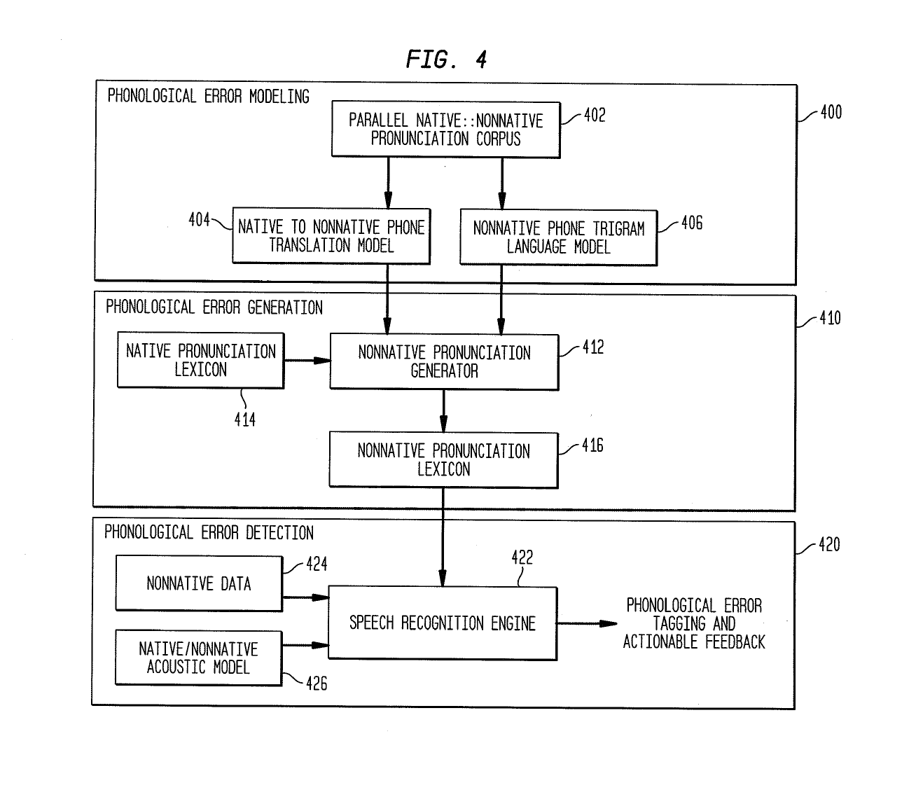

FIG. 4 is a flow chart of a non-native target language pronunciation method, according to an exemplary embodiment of the present disclosure. The method generally comprises a phonological error modeling 400, phonological error generation 410, and phonological error detection 420. In some embodiments, phonological error modeling 400 and phonological error generation 410 may be performed by the PEM system of the present disclosure, and phonological error detection 420 may be performed by a CAPT system. In other embodiments, phonological error modeling 400, phonological error generation 410, and phonological error detection 420 may be performed by the CAPT system (with phonological error modeling 400 and phonological error generation 410 being performed by a PEM sub-system of the CAPT). In block 402 of the phonological error modeling process 400, a parallel corpus of non-native (L1-specific) target language pronunciation patterns are obtained. The parallel corpus is used to train a native to non-native phone translation model 404 and a non-native phone language model 406. The translation model 404 learns the mapping between native and non-native phones. The non-native phone language model 406 models the likelihood of a given non-native phone sequence. In block 412 of the phonological error generation process 410, the translation and language models 404, 406 are used by a non-native pronunciation generator along with native pronunciation lexicon 414, to generate likely mispronunciations of a L1-specific population. In block 416, all the generated normative pronunciations are stored in a non-native pronunciation lexicon. In block 422 of the phonological error detection block 420, the non-native pronunciation lexicon can be used by a speech recognition engine in conjunction with the native/non-native acoustic model to detect and diagnose phonological errors in an utterance 424 spoken in the non-native target language (L2) by a language learner.

### System Evaluation

The PEM system using MT was evaluated against a prior art edit distance (ED) based system. The PEM system was used to detect phonological errors in a test set. In order to build the edit distance based baseline system, phonological errors were initially extracted using ED from the training set. Phonological errors were ranked by occurrence probability. From empirical observations, the cutoff probability threshold was set at 0.001. This provided approximately 1500 frequent error patterns. The frequent error rules were loaded into the Lingua Phonology Perl module to generate non-native phone sequences. The tool was constrained to apply rules only once for a given triphone context as the edit distance approach does not model interdependencies between error rules. The N-best list obtained from the Lingua module was ranked by the occurrence probability of the rules that were applied to obtain that particular alternative. The non-native lexicon was created with an N-best cutoff of 4 so that it's comparable to the non-native lexicon produced by the PEM system. The PEM and ED systems were evaluated using the following metrics: (i) overall accuracy of the system; (ii) diagnostic performance as measured by precision and recall; and (iii) F-1 score, which is the harmonic mean of precision and recall. This provided one number to track changes in operating point of the systems. These metrics were calculated for the phone detection and phone identification tasks along with their corresponding human annotator upper bounds.

Phone error detection is defined as the task of flagging a phoneme as containing a mispronunciation. The accuracy metric measures overall classification accuracy of the system on the phone error detection task, while precision and recall measure the diagnostic performance of the system. Precision measures the number of correct mispronunciations over all the mispronunciations flagged by the system. Recall measures the number of correct mispronunciations over the total number of mispronunciations found in the test set (as flagged by the annotator).

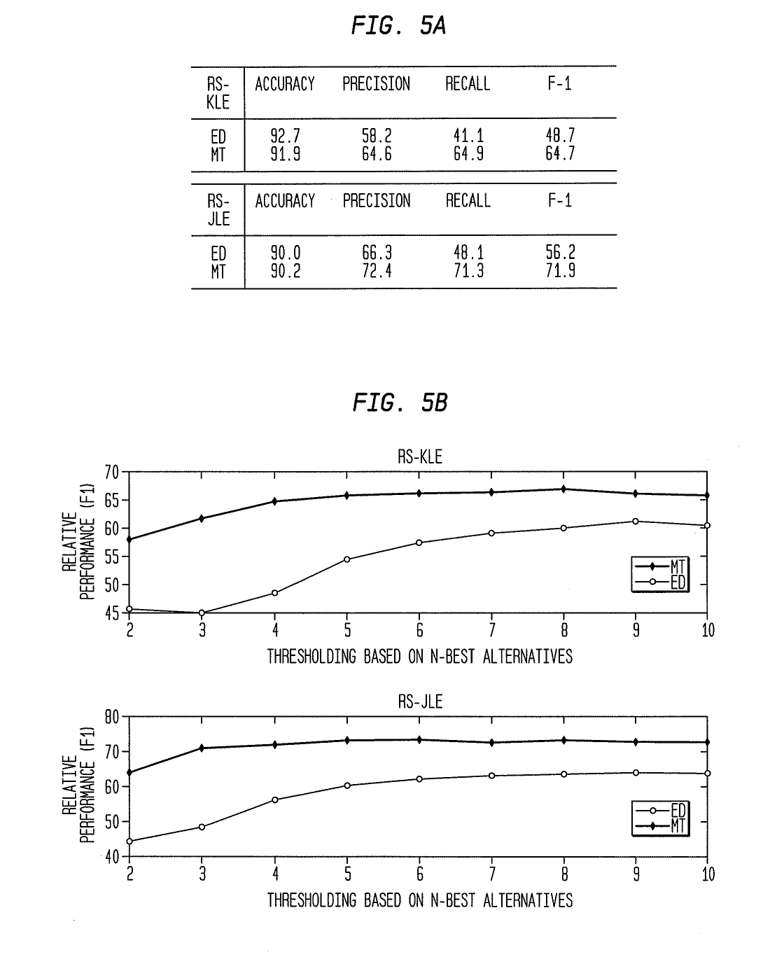

FIG. 5A is a table showing the performances of the PEM and ED systems normalized to Human performance (set at 100%) in phone error detection. As shown in FIG. 5A, across the corpora, the PEM system of the present disclosure achieved between 65 to 72% of the performance achieved by humans on F-1 score. The more holistic modeling approach employed by the PEM system is evidenced by higher normalized performance (NP) in recall in comparison to precision. The PEM system achieves a 28-33% relative improvement in F-1 in comparison to the ED system. FIG. 5B shows NP on F-1 for varying number of pronunciation alternatives. There is a significant increase in performance for lexicons with 3-4 best alternatives beyond which the performance asymptotes.

Phone identification is defined as the task of identifying the phone label spoken by the learner. The identification accuracy metric measures the overall performance on the identification task. Precision measures the number of correctly identified error rules over the total number of error rules discovered by the system. Recall measures the number of correctly identified error rules over the number of error rules in the test set (as annotated by the human annotator).

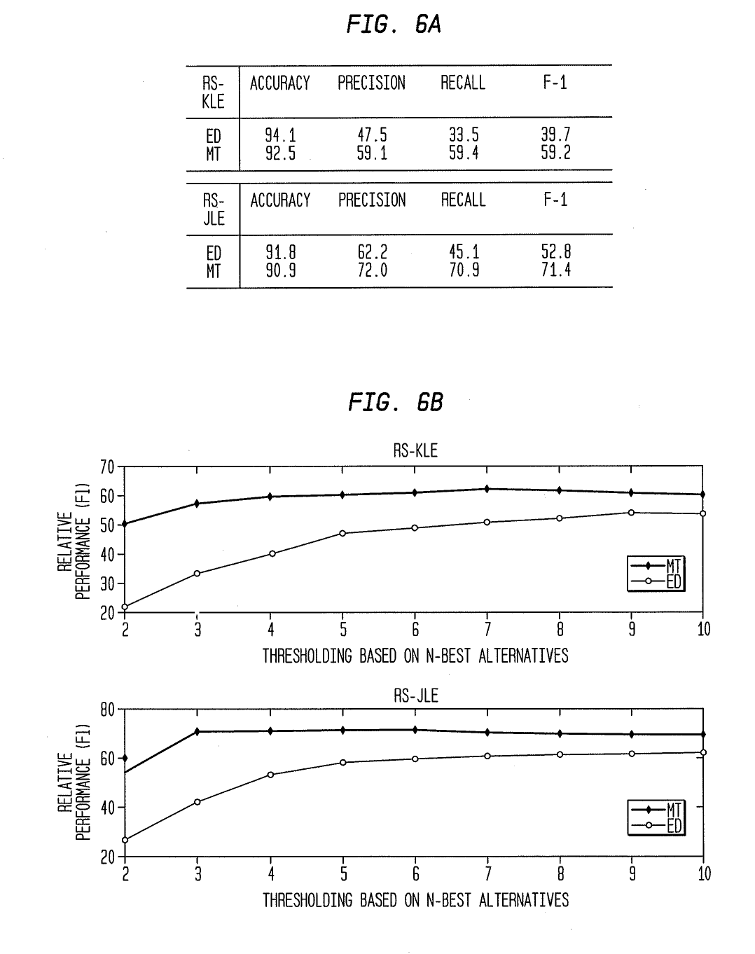

FIG. 6A is a table showing the performances of the PEM and ED systems normalized to Human performance (set at 100%) in phone error identification. As shown in FIG. 6A, the PEM system achieved a 59-71% NP on F1-score across the corpora. This constitutes a 35-49% relative improvement compared to the ED system. Given the difficulty of error identification task, it should be noted that the performances are relatively lower in comparison to phone error detection. Similar to the behavior in phone error detection, FIG. 6B shows that the highest NPs are achieved with 3-4 best alternatives.

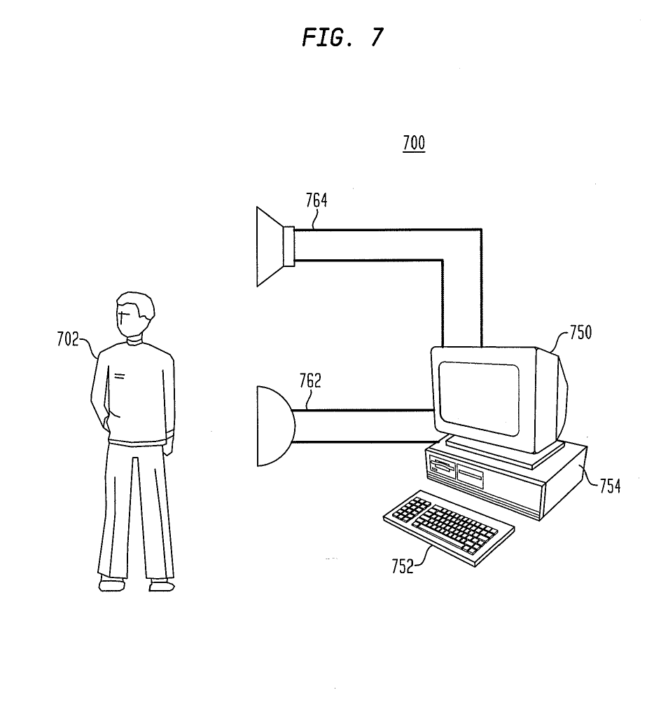

FIG. 7 is a schematic block diagram of an exemplary embodiment of a language instruction system 700 including a computer system 750 and audio equipment suitable for teaching a target language to user 702, in accordance with the principles of present disclosure. Language instruction system 700 may interact with one user 702 (language student), or with a plurality of users (students). Language instruction system 700 may include computer system 750, which may include keyboard 752 (which may have a mouse or other graphical user-input mechanism embedded therein) and/or display 754, microphone 762 and/or speaker 764. Language instruction system 700 may further include additional suitable equipment such as analog-to-digital converters and digital-to-analog converters to interface between the audible sounds received at microphone 762, and played from speaker 764, and the digital data indicative of sound stored and processed within computer system 750.

The computer 750 and audio equipment shown in FIG. 7 are intended to illustrate one way of implementing the system and method of the present disclosure. Specifically, computer 750 (which may also referred to as “computer system 750”) and audio devices 762, 764 preferably enable two-way audio communication between the user 702 (which may be a single person) and the computer system 750. Computer 750 and display 754 enable visual displays to the user 702. If desired, a camera (not shown) may be provided and coupled to computer 750 to enable visual data to be transmitted from the user to the computer 750 to enable instruction to obtain data on, and analyze, visual aspects of the conduct and/or speech of the user 702.

In one embodiment, software for enabling computer system 750 to interact with user 702 may be stored on volatile or non-volatile memory within computer 750. However, in other embodiments, software and/or data for enabling computer 750 may be accessed over a local area network (LAN) and/or a wide area network (WAN), such as the Internet. In some embodiments, a combination of the foregoing approaches may be employed. Moreover, embodiments of the present disclosure may be implemented using equipment other than that shown in FIG. 7. Computers embodied in various modern devices, both portable and fixed, may be employed including but not limited to Personal Digital Assistants (PDAs), cell phones, among other devices.

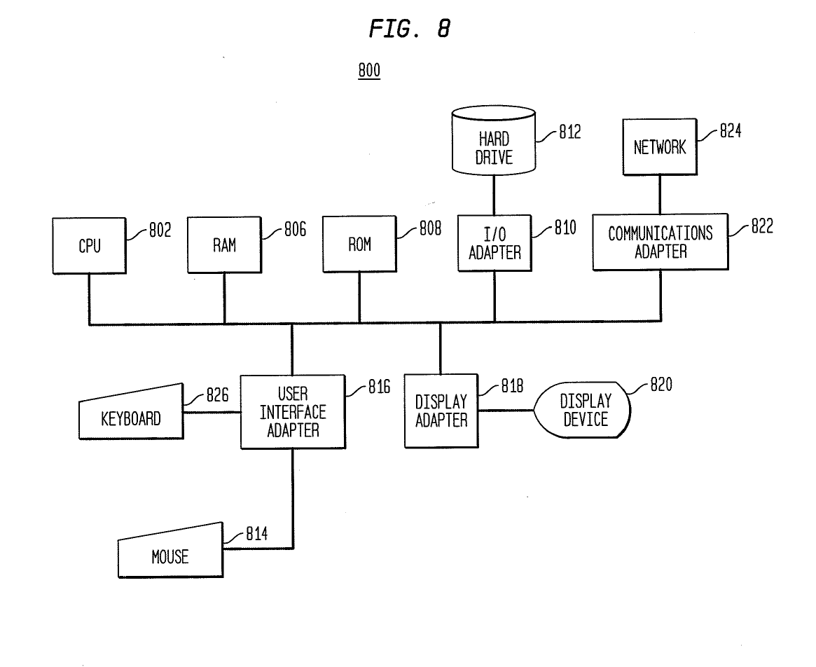

FIG. 8 is a block diagram of a computer system 800 adaptable for use with one or more embodiments of the present disclosure. Computer system 800 may generally correspond to computer system 750 of FIG. 7. Central processing unit (CPU) 802 may be coupled to bus 804. In addition, bus 804 may be coupled to random access memory (RAM) 806, read only memory (ROM) 808, input/output (I/O) adapter 810, communications adapter 822, user interface adapter 806, and display adapter 818.

In an embodiment, RAM 806 and/or ROM 808 may hold user data, system data, and/or programs. I/O adapter 810 may connect storage devices, such as hard drive 812, a CD-ROM (not shown), or other mass storage device to computing system 600. Communications adapter 822 may couple computer system 800 to a local, wide-area, or global network 824. User interface adapter 816 may couple user input devices, such as keyboard 826, scanner 828 and/or pointing device 814, to computer system 800. Moreover, display adapter 818 may be driven by CPU 802 to control the display on display device 820. CPU 802 may be any general purpose CPU.

While exemplary drawings and specific embodiments of the disclosure have been described and illustrated, it is to be understood that that the scope of the invention as set forth in the claims is not to be limited to the particular embodiments discussed. For example, but not limitation, one of ordinary skill in the speech recognition art will appreciate that the MT approach may also be used to construct a non-native speech recognition system. That is, a system to recognize words spoken by a non-native speaker with higher degree of accuracy by modeling the variations that they would produce while speaking. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

1. A method for teaching a user a non-native language, the method comprising the steps of:
creating, in a computer process, models representing phonological errors in the non-native language; and
generating with the models, in a computer process, non-native pronunciations for a native pronunciation.

2. The method of claim 1, further comprising the step of using the non-native pronunciations for detecting, in a computer process, phonological errors in an utterance spoken in the non-native language by the user.

3. The method of claim 1, wherein the models include a native to non-native phone translation model.

4. (canceled)

5. The method of claim 1, wherein the models include a non-native phone language model.

6. The method of claim 1, wherein the creating step includes training the models with parallel native pronunciation and non-native pronunciation patterns.

7. The method of claim 6, wherein the parallel native pronunciation and non-native pronunciation patterns respectively include canonical sequences and non-native phone sequences.

8. The method of claim 1, wherein the creating step is performed as a machine translation method.

9. The method of claim 1, wherein the creating step includes aligning native pronunciations with corresponding non-native pronunciations.

10. The method of claim 9, wherein the creating step includes transforming the aligned native and non-native pronunciations into chunks of phone-based alignments, the chunks of phone-based alignments generating a phone translation model.

11. The method of claim 1, wherein the creating step includes using annotated native and non-native phone sequences to generate a non-native phone language model.

12. A system for teaching a user a non-native language, the system comprising:
a word aligning module for aligning native pronunciations with corresponding non-native pronunciations, the aligned native and non-native pronunciations for use in creating a native to non-native phone translation model;
a language modeling module for generating a non-native phone language model using annotated native and non-native phone sequences; and
a non-native pronunciation generator for generating non-native pronunciations using the phone translation and phone language models.

13. The system of claim 12, wherein the system is for use with a computer assisted pronunciation training system.

14. (canceled)

15. The system of claim 12, wherein the system comprises a phonological error modeling system.

16. (canceled)

17. The system of claim 13, wherein the computer assisted pronunciation training system can be used for non-native speech recognition.

18. The system of claim 12, further comprising a trainer for transforming the aligned native and non-native pronunciations into chunks of phone-based alignments, the chunks of phone-based alignments defining the phone translation model.

19. The system of claim 12, further comprising a speech recognition engine for detecting phonological errors in an utterance spoken in the non-native language by the user.

20. The system of claim 19, wherein the system is for use with a computer assisted pronunciation training system.

21. (canceled)

22. The system of claim 19, wherein the system comprises a phonological error modeling system.

23. The system of claim 19, wherein the system comprises a computer assisted pronunciation training system.

24. A system for teaching a user a non-native language, the system comprising:
a memory containing instructions;
a processor executing the instructions contained in the memory, the instructions for: aligning native pronunciations with corresponding non-native pronunciations, the aligned native and non-native pronunciations for use in creating a native to non-native phone translation model;
generating a non-native phone language model using annotated native and non-native phone sequences; and
generating non-native pronunciations using the phone translation and phone language models.

25. (canceled)
